(19) United States
(12) Patent Application Publication
(10) Pub. No.: US 2004/0044679 A1
(43) Pub. Date: Mar. 4, 2004

(54) System and method for remotely generating reports

(76) Inventors: Kuo-Chin Chang, Tu-chen (TW); WenZhen Ma, Shenzhen (CN); Nong Ji, Shenzhen (CN); Chia-Chi Huang, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,649

(22) Filed: Dec. 27, 2002

(30) Foreign Application Priority Data
Aug. 30, 2002 (TW) 91119736

(51) Int. Cl. G06F 17/00; G06F 7/00

(52) U.S. Cl. 707/102

(57) ABSTRACT

A system and method for generating reports from a website program residing in a web server (30). The system comprises: a data collection module (41) that periodically gathers data to update a database (51); a user interface module (42) that manages users' requests, said user requests including requests for logon and requests for reports; a data service module (43) that retrieves from the database data requested for generation of reports; and a report generation module (44) that encapsulates instances of requests for reports and instantiates said instances to generate reports based on data supplied by the data service module in accordance with requests for reports. Users can access the system through web browsers to request required reports. One example of such reports is reports containing financial data.

### BACKGROUND OF THE INVENTION

1. Field of the Invention

The present invention relates to a system and method for remotely generating reports, and especially to a system and method for generating reports from a website program residing on a web server according to online queries.

2. Prior Art

A typical enterprise employs numerous clerks to produce financial information. The clerks spend a great deal of time producing financial reports that include accounts payable and accounts receivable. Managers of the enterprise use such reports to assist decision-making. Suppliers to the enterprise can obtain the information on accounts payable. A typical report generating system can not only automatically generate various kinds of financial reports, but also use modern communication techniques to delivery such information to clients. The recent rapid development of active server pages has made interactive websites more and more successful. Active server pages require only a thin client side architecture, so that only a web browser is needed on the client side. This is more convenient and less expensive than normal distributed program architecture.

Report generating systems employing active server pages have already highly developed. U.S. Pat. No. 6,055,541 discloses an automatic report generating system. FIG. 4 is a block diagram of system, which comprises a client side 120 and a server side 140 interconnected by the Internet/an intranet 160. On the client side 120, a computer 180 runs a web browser (not shown). The computer 180 may be any suitable type of computer such as an Apple computer, IBM or IBM compatible computer, or a UNIX workstation. On the server side 140, a web server 200 runs on an appropriate machine as is known in the art. The web server runs an Internet information server 220 such as Microsoft Information Server or Peer Web Service. The Internet information server 220 includes an Active Server Pages framework 240, which in turn incorporates a scripting engine 260 operating therein. In response to requests from the web browser, the Internet information server 220 generates Hypertext Markup Language (HTML) files 280 using Active Server Page (ASP) files 300.

The system disclosed in U.S. Pat. No. 6,055,541 is still relatively rudimentary. The locating technology disclosed does not enable dynamic alteration of data stored in a database. The system is limited to using static data to actively produce reports. In particular, there is no means for dealing with constantly varying data, and no means for producing various modes of reports according to demand.

### SUMMARY OF THE INVENTION

It is a general object of the present invention to provide a system and method for generating reports from a website program residing on a web server, whereby reports are actively generated according to online queries.

It is another object of the present invention to provide a system and method for generating reports from a website program residing on a web server, whereby reports can be obtained through the Internet or an intranet by enterprise managers and suppliers using web browsers.

In order to achieve the aforementioned objects, the present invention provides a system for generating reports from a website program residing in a web server. The system comprises: a data collection module that periodically gathers data to update a database; a user interface module that manages user requests, said user requests including requests for logon and requests for reports; a data service module that retrieves from the database data requested for generation of reports; and a report generation module that encapsulates instances of requests for reports and instantiates said instances to generate reports based on data supplied by the data service module in accordance with requests for reports.

In order to achieve the aforementioned objects, the present invention also provides a method for generating a report from a website program residing in a web server, the method comprising the following steps: (i) collecting data to update a database periodically; (ii) managing user requests, said user requests including requests for logon and requests for reports; and (iii) instantiating a instance of a report generation module to generate a report in accordance with a particular request for the report, said report generation module encapsulating instances of requests for reports.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of architecture of a networked computer system in accordance with a preferred embodiment of the present invention for generating reports from a website program residing in a web server;

FIG. 2 is similar to FIG. 1, but schematically shows detailed architecture of a report generating system of the networked computer system;

FIG. 3 is a flow chart of generating reports in accordance with a preferred embodiment of the present invention; and

FIG. 4 is a schematic diagram of system architecture of a conventional automatic report generating system.

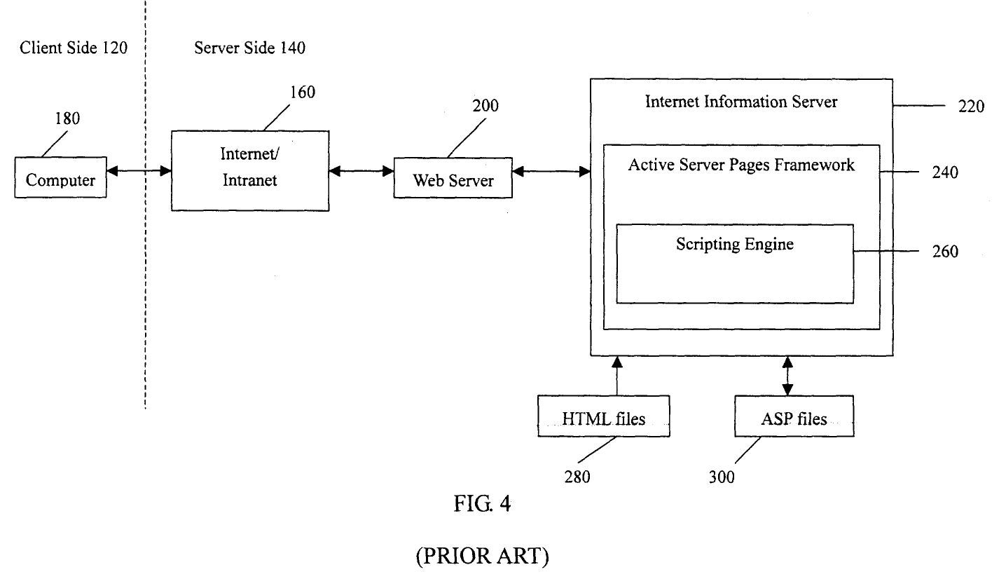

### DETAILED DESCRIPTION OF PREFERRED EMBODIMENTS OF THE INVENTION

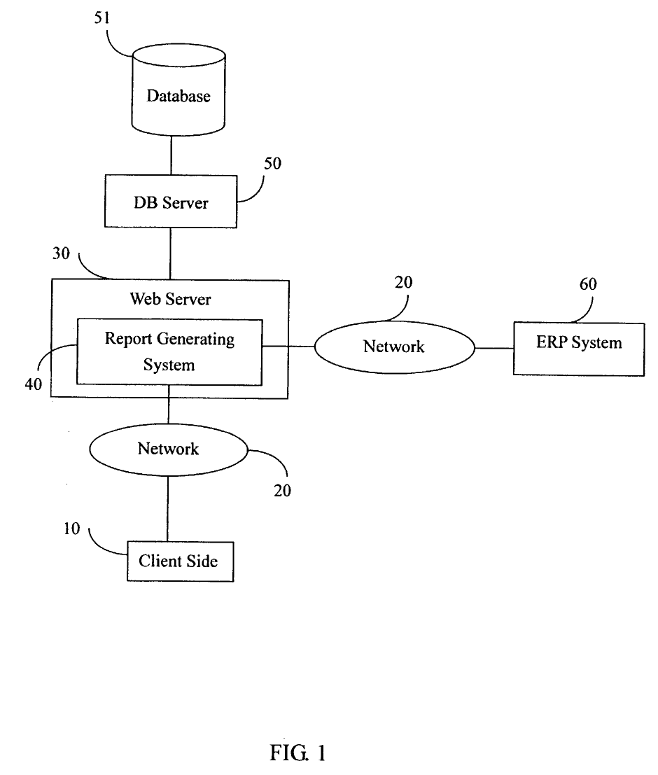

FIG. 1 is a schematic diagram of architecture of a networked computer system in accordance with the present invention for generating reports from a website program residing in a web server. The networked computer system comprises a plurality of client sides 10 (only one shown), a network 20, a web server 30, a report generating system 40, a database server 50, a database 51, and at least one Enterprise Resource Planning (ERP) system 60. The client sides 10, the web server 30 and the ERP system 60 are interconnected via the network 20. The network 20 can be the Internet or an intranet. The web server 30 may be any suitable type of machine as is known in this art, and each client side 10 runs a web browser (not shown) to interact with the web server 30.

The following description of and involving the report generating system 40 relates to production of financial data. However, this is provided by way of example only. The report generating system 40 is not limited to production of financial data. In general, the report generating system 40 can be used to provide any kind of data, particularly when any one or more of the following circumstances exist: the reports are generated from current data, the reports are generated from a request over a distributed network, the reports are dynamically generated, and/or the reports are intended for an managerial level audience and require a high quality of presentation.

The report generating system 40 running on the web server 30 actively generates financial reports according to online queries, and delivers such reports through the network 20. The report generating system 40 can also use the network 30 to periodically access the remote ERP system 60 in order to obtain financial data on an enterprise and store such data in the database 51. The database 51 stores a plurality of tables of financial information and user authorities, and a plurality of temporary tables. The report generating system 40 can use such tables to produce financial reports and manage user authorities, and the report generating system 40 allows the client sides 10 to retrieve the requested reports through respective web browsers.

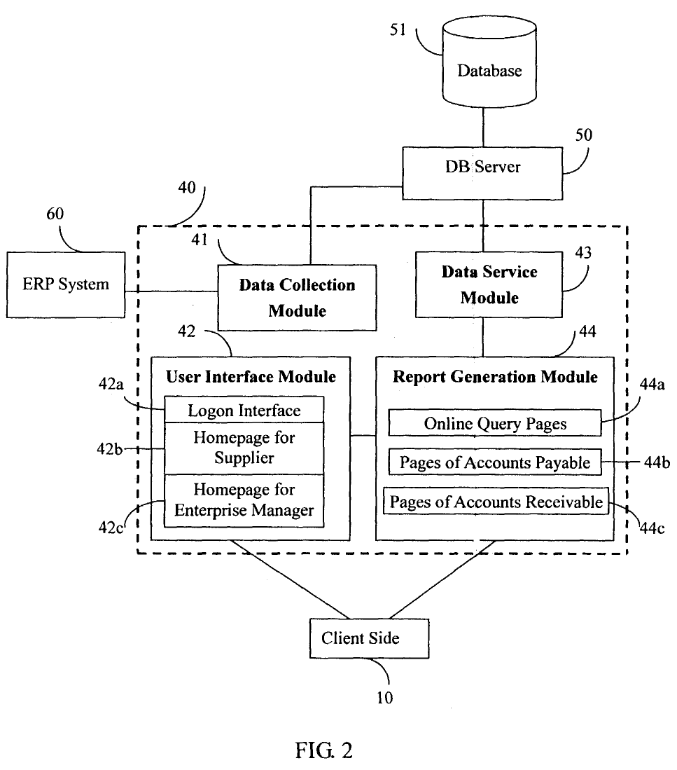

FIG. 2 is similar to FIG. 1, but schematically shows detailed architecture of the report generating system 40. The report generating system 40 comprises a data collection module 41, a user interface module 42, a data service module 43, and a report generation module 44. The data collection module 41 periodically obtains financial data of an enterprise according to parameters set by a web administrator, and stores such data in the database 51. The data collection module 41 can be implemented by using known programming languages such as Visual Basic (VB). The data collection module 41 as a program calls the interfaces provided by the ERP system 60 to obtain the requested data, and then uses Structure Query Language (SQL) command lines to store such data in the database 51.

The user interface module 42 manages user requests, said user requests including requests for logon and requests for financial reports. When each client side 10 uses its web browser to log on the report generating system 40, the user interface module 42 provides a user logon interface 42a to confirm user authority, and then according to the user authority generates a corresponding logon homepage. In the preferred embodiment of the present invention, the logon homepages include a homepage for supplier 42b and a homepage for enterprise manager 42c. The logon homepages 42b, 42c each contain a plurality of hyperlinks. The hyperlinks can send requests for relevant financial reports to the web server 30.

Said requests for financial reports comprise online query requests, requests for accounts payable reports, and requests for account receivable reports. In answer to such requests, the report generation module 44 uses the data supplied by the data service module 43 and active server pages to generate HTML pages. The HTML pages include online query pages 44a, pages of accounts payable 44b, and pages of accounts receivable 44c. The report generation module 44 comprises a plurality of Active Server Page (ASP) files that are written in response to requests for financial reports. In the field of this invention, such ASP files are known as one kind of so-called “instances.” When a user clicks a hyperlink in either of the logon homepages 42b, 42c to send a request for a financial report, the relevant ASP file is dynamically compiled to generate an HTML page containing the financial report, and the HTML page is sent to the relevant client side 10 through Hypertext Transfer Protocol (HTTP). In the field of this invention, such dynamic compiling of said ASP file is known as one kind of so-called “instantiating.”

ASP is the component used to produce server-side scripted templates that generate dynamic and interactive web server applications. The ASP framework incorporates an appropriate scripting engine (e.g. VB Script, Java Script, etc.) to allow embedding of special program codes in web pages. These codes can be used to access a database, provide query functions, show reports in a variety of modes, and so on. That is an important feature because it means that no special software other than a web browser is needed on any of the client sides 10 to view the financial reports.

The data service module 43 comprises a plurality of stored procedures that access the database 51 to collect data requested for generation of financial reports. Each stored procedure comprises a plurality of SQL command lines that can retrieve data from the database 51 according to query conditions set in the command lines. Thus the report generation module 44 uses functions in ASP files to call these stored procedures to access the database 51.

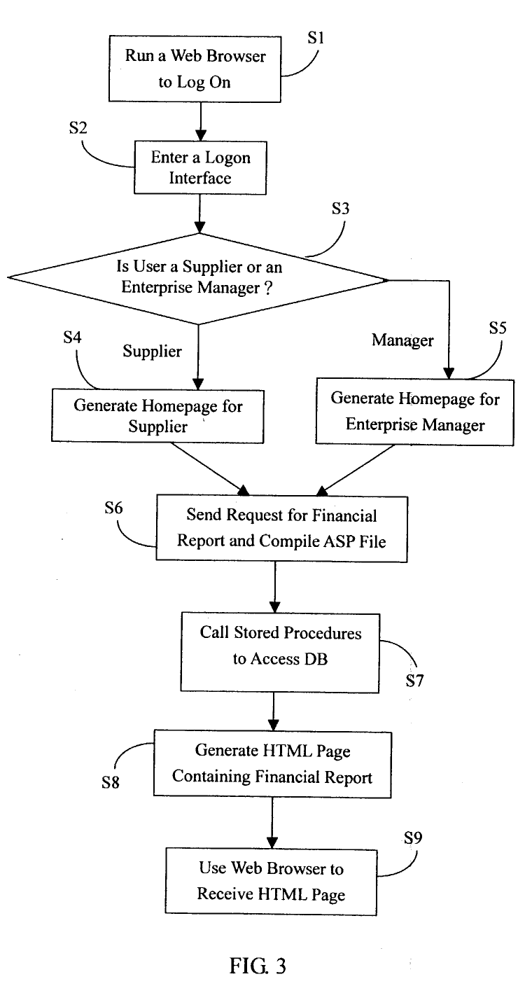

FIG. 3 is a flow chart of generating reports in accordance with a preferred embodiment of the present invention. A user at one client side 10 runs a web browser to visit the report generating system 40 (step S1). The user primarily uses the logon interface 42a provided by the user interface module 42 to log on (step S2). The user interface module 42 determines whether the user is a supplier or an enterprise manager, according to the user's authority (step S3). If the user is a supplier, the user interface module 42 generates the homepage for supplier 42b, and sends it to the client side 10 (step S4). If the user is an enterprise manager, the user interface module 42 generates the homepage for enterprise manager 42c, and sends it to the client side 10 (step S5). The user clicks at least one of the hyperlinks residing in his/her logon homepage to send a request for a financial report. The web server 30 then dynamically compiles the relevant ASP file provided by the report generation module 44 (step S6). The ASP file includes script for calling the stored procedures in the data service module 43 to access the database 51 to collect data requested for generation of the financial report (step S7). The ASP file also includes script for actively generating the financial report in any of a variety of modes. Thus the report generation module 44 uses data supplied by the data service module 43 and the ASP file to generate the HTML page containing the requested financial report (step S8). The client side 10 uses the web browser to receive such HTML page, thereby completing the delivery of the financial report (step S9).

While the present invention has been described above, it should be understood that it has been presented by way of example only and is not to be limited by the above-described exemplary embodiments, but should be defined only in accordance with the following claims and their equivalents.

What is claimed is:

1. A system for generating reports from a website program residing in a web server, the system comprising:
a data collection module that periodically obtains data to update a database;
a user interface module that manages user requests;
a data service module that retrieves from the database data requested for generation of reports; and
a report generation module that encapsulates instances of requests for reports and instantiates said instances to generate reports based on data supplied by the data service module in accordance with requests for reports.

2. The system of claim 1, wherein the user requests comprise requests for logon and requests for reports.

3. The system of claim 1, wherein the user interface module provides a logon interface to confirm users' authorities when the users log on.

4. The system of claim 1, wherein the user interface module further provides a plurality of user homepages, and generates a relevant homepage according to a particular user's authority.

5. The system of claim 4, wherein the user homepages each include at least one hyperlink through which a request for a report is sent to the web server.

6. The system of claim 1, wherein the data service module comprises a plurality of stored procedures that can be called by the report generation module to collect from the database data requested for reports.

7. A method for generating a financial report from a report generating system residing in a web server, the method comprising the following steps:
(a) collecting data to update a database periodically;
(b) managing user requests, the user requests including requests for logon and requests for reports; and
(c) instantiating an instance of a report generation module to generate a report in accordance with a particular request for the report, said report generation module encapsulating instances of requests for reports.

8. The method of claim 7, wherein step (b) further comprises the step of: providing a logon interface to confirm a user's authority when the user logs on.

9. The method of claim 7, wherein step (b) further comprises the step of: generating a relevant user homepage according to a user's authority.

10. The method of claim 9, wherein the user homepage includes at least one hyperlink through which the request for a report is sent to the web server.

11. The method of claim 7, wherein step (c) further comprises the step of: calling a plurality of stored procedures to access the database to collect data requested for generation of the report.

12. The method of claim 11, wherein step (c) further comprises the step of: using data retrieved from the database and active server pages to generate a hypertext markup language page containing the report.

13. The method of claim 12, wherein step (c) further comprises the step of: sending the hypertext markup language page containing the report to a client browser using Hypertext Transfer Protocol.

14. A networked computer system comprising:
a plurality of client sides;
at least one enterprise resource planning system;
a database; and
a report generating system residing on a web server, said web server being coupled with the client sides and the enterprise resource planning system by a network, the report generating system comprising:
a data collection module that periodically obtains data from the enterprise resource planning system to update the database;
a user interface module that manages user requests, said user requests including requests for logon and requests for reports;
a data service module that retrieves from the database data requested for generating reports; and
a report generation module that encapsulates instances of requests for reports and instantiates said instances to generate reports based on data supplied by the data service module in accordance with requests for reports.

15. A method of obtaining financial information via the Internet, comprising:
(1) running a Web Browser to log on;
(2) entering a logon interface;
(3) creating different home pages depending upon either a supplier or a enterprise manager;
(4) sending a request for a financial report and compiling ASP files;
(5) calling stored processes to access a corresponding financial database;
(6) generating HTML pages containing a financial report; and
(7) using the Web Browser to receive the HTML pages; wherein said financial database is automatically periodically updated.
